(19) United States
(12) Patent Application Publication
(10) Pub. No.: US 2013/0021528 A1
(43) Pub. Date: Jan. 24, 2013

(54) Image Transmission and Display Method Comply with Chromaticity and Visual Fidelity Principle

(71) Applicant: Shichang Liu, Xi'an (CN)

(72) Inventor: Shichang Liu, Xi'an (CN)

(21) Appl. No.: 13/504,105

(22) PCT Filed: Feb. 28, 2011
(86) PCT No.: PCT/CN11/00327

§ 371 Date: Jun. 14, 2012

(51) Int. Cl. H04N 9/69

(52) U.S. Cl. 348/675; 348/E09.054

(57) ABSTRACT

This invention discloses an image transmission and display method complies with both chromaticity and visual fidelity principles. It is in the technical field of image transmission and display. In order to totally eliminate factors that affect image reproduction fidelity during process of image transmission and reproduction on display devices (including channel independence and space independence of three primary colors, red-shift effect, gamma correction, methods to generate brightness information and chromatic difference information, gamma correction for all kinds of display devices), this invention created a set of mathematical models and methods. With the invention, data flows are processed complying with both chromaticity and visual fidelity to ensure hues of reproduced image on display device remain unchanged, gray is reproduced accurately and chromaticity coordinates ratio remains unchanged as well. This is a universal method to ensure fidelity for image transmission and display, and can be widely applied on televisions, computers and mobile telecommunication devices. Furthermore, it provides support of chromaticity and methodology for color management system, design and development of associated software and hardware, and system which is a combination of digital high definition television and computer.

### I. TECHNICAL FIELD

This invention is an image transmission and display method complies with both chromaticity and visual fidelity principle. It can ensure the accuracy of image reproduction. The invention is in technology field of electronic image transmission and display. The main application fields include the electronic image transmission and display devices (such as television, cell phone and computer), color management system, TV and multimedia computer system, and associated integrated device design and manufacture.

### II. TECHNICAL BACKGROUND

High fidelity image display Quality is essential to color digital television and multimedia computer system. The widely used digital TV and computer integrated multimedia computer system has a lot of advantages. It plays an important role in information infrastructure and is used on commercial, medical, publishing and printing, military tactical display, and satellite image and industry facilities. In order to accurately display the image, the image color information needs to be processed precisely. Color aberration will result in image distortion. Therefore, the color display and transmission technology developed based on the television display technology need a fundamental revolution to meet the technology need of high definition TV, computer image, the diversity of monitors and computerized digital TV. The revolution can be summarized as follows:

1. The difficulty to describe the display chromaticity had prevented the creation of real color chromaticity standard on 525-line television system; this also makes the color displayed on screen is always not as good reproduction as color photo. The main reason for that is the channel non-independency of the three primary colors. The common used GOG, PLCC models can't guarantee channel independency of the three primary colors. For instance, it has been recognized Doppler effect can result in the red shift effect to light wave, however the side effect on the channel independency and the data loss of the television image, aerial image and medical image due to red shift are overlooked.

2. As to color space, primaries' dependency also affects reproduction accuracy of electronic image. The conventional equation which uses linear superposition principle to produce color can't eliminate chromaticity aberration caused by space dependency. For instance, when grey signal increase gradually, colors displayed on CIE x,y chromaticity diagram don't have the same chromaticity coordinates;

3. After gamma correction, only seven colors (white of equal T, three primaries—red, green, blue and secondary colors—cyan, magenta, and yellow) are not affected by the nonlinear characteristic of the monitor. For other color, ratio of chromaticity coordinate has changed. Total gamma value of image system should be equal to 1, but for the reason of contrast, it has always been given a value greater than 1. All these known technical barriers that cause chromaticity aberration and image detail loss need to be broken.

4. It is impossible to find a gamma correction curve that works on TV sets of various technologies such as CRT, PDP, LCD, LED, etc. so, SMPTE standard proposed: correction of certain display device should be done by the device itself, so same chromaticity can be reproduced on either current or future monitors. This leads to the urgent need for a universal, cross-device gamma correction method. To overcome the four limitations listed above, the new solution should abandon the approximate algorithm which doesn't conform to colorimetric theory and causes error accumulation. The new way should comply with color management principles. Otherwise, chromaticity aberration issue with digital television and computer images will remain and so-called high-definition digital images will be more in name than in reality. The reason is enhancing image resolution does not help with solving chaos of chromaticity processing method. The purpose of this invention is to provide a comprehensive, universally applicable solution that works on both television image display and computer. As a result, this invention doesn't use linear method to deal with non-linear color problem approximately. Instead, it creates some nonlinear equations which are not very complicated. In practice, other than gray calibration equation, the color processing methods are linear or quadratic functions which can be solved using analytical algorithm.

### III. INVENTION CONTENT

Please note, in this document we use unified naming convention and label symbol in mathematical models; we will give description of the math symbol when it is used the first time.

1. XYZ—rᵥgᵥbᵥ—dᵣd_{g}d_{b} Color Space Transform Equation Based on the New Principle

Features and application:

The application of this equation is to derive the XYZ—rᵥ′gᵥ′bᵥ′—dᵣd_{g}d_{b} gamma correction equation. The equation calculates the three primaries rgb based on the given tristimulus values XYZ With the known rgb, the driving values dᵣ, d_{g}, d_{b}which are used to display tristimulus values can be obtained. Gray core values rᵥₗ gᵥₗ bᵥ in the equation have the reference primary component valuesand are related to white balance and gamma correction. Combine these parameters with color appearance keeping parameter λ can make the color have the same hue and the same overall color appearance before and after conversion. However the use of this equation leads to the image colors dim, therefore this equation need further adjustment to add the gamma correction function.

The format of XYZ—rᵥgᵥbᵥ—dᵣd_{g}d_{b} color space transformation equation:

To improve algorithm efficiency and obtain accurate conversion results comply with colorimetric principles, the transformation equation has three similar formats rᵥgb, rgᵥb, rgbᵥ, and they are all quadratic equations. These equations divide the entire color space into three segments for conversion calculation. According to the main hue of the to-be-converted color XYZ, choose one format to implement the XYZ conversion. The three formats are:

$$\{ \begin{matrix}λ X = ( 1 - {r}_{v} ) ( 1 - g ) ( 1 - b ) {X}_{k} + {r}_{v} ( 1 - g ) ( 1 - b ) {X}_{r} + ( 1 - {r}_{v} ) g ( 1 - b ) {X}_{g} + \\ ( 1 - {r}_{v} ) ( 1 - g ) {bX}_{b} + ( 1 - {r}_{v} ) {gbX}_{c} + {r}_{v} ( 1 - g ) {bX}_{m} + {r}_{v} g ( 1 - b ) {X}_{y} + {r}_{v} {gbX}_{W} \\ λ Y = ( 1 - {r}_{v} ) ( 1 - g ) ( 1 - b ) {Y}_{k} + {r}_{v} ( 1 - g ) ( 1 - b ) {Y}_{r} + ( 1 - {r}_{v} ) g ( 1 - b ) {Y}_{g} + \\ ( 1 - {r}_{v} ) ( 1 - g ) {bY}_{b} + ( 1 - {r}_{v} ) {gbY}_{c} + {r}_{v} ( 1 - g ) {bY}_{m} + {r}_{v} g ( 1 - b ) {Y}_{y} + {r}_{v} {gbY}_{W} \\ λ Z = ( 1 - {r}_{v} ) ( 1 - g ) ( 1 - b ) {Z}_{k} + {r}_{v} ( 1 - g ) ( 1 - b ) {Z}_{r} + ( 1 - {r}_{v} ) g ( 1 - b ) {Z}_{g} + \\ ( 1 - {r}_{v} ) ( 1 - g ) {bZ}_{b} + ( 1 - {r}_{v} ) {gbZ}_{c} + {r}_{v} ( 1 - g ) {bZ}_{m} + {r}_{v} g ( 1 - b ) {Z}_{y} + {r}_{v} {gbZ}_{W}\end{matrix} \\ \{ \begin{matrix}λ X = ( 1 - r ) ( 1 - {g}_{v} ) ( 1 - b ) {X}_{k} + r ( 1 - {g}_{v} ) ( 1 - b ) {X}_{r} + ( 1 - r ) {g}_{v} ( 1 - b ) {X}_{g} + \\ ( 1 - r ) ( 1 - {g}_{v} ) {bX}_{b} + ( 1 - r ) {g}_{v} {bX}_{c} + r ( 1 - {g}_{v} ) {bX}_{m} + {rg}_{v} ( 1 - b ) {X}_{y} + {rg}_{v} {bX}_{W} \\ λ Y = ( 1 - r ) ( 1 - {g}_{v} ) ( 1 - b ) {Y}_{k} + r ( 1 - {g}_{v} ) ( 1 - b ) {Y}_{r} + ( 1 - r ) {g}_{v} ( 1 - b ) {Y}_{g} + \\ ( 1 - r ) ( 1 - {g}_{v} ) {bY}_{b} + ( 1 - r ) {g}_{v} {bY}_{c} + r ( 1 - {g}_{v} ) {bY}_{m} + {rg}_{v} ( 1 - b ) {Y}_{y} + {rg}_{v} {bY}_{W} \\ λ Z = ( 1 - r ) ( 1 - {g}_{v} ) ( 1 - b ) {Z}_{k} + r ( 1 - {g}_{v} ) ( 1 - b ) {Z}_{r} + ( 1 - r ) {g}_{v} ( 1 - b ) {Z}_{g} + \\ ( 1 - r ) ( 1 - {g}_{v} ) {bZ}_{b} + ( 1 - r ) {g}_{v} {bZ}_{c} + r ( 1 - {g}_{v} ) {bZ}_{m} + {rg}_{v} ( 1 - b ) {Z}_{y} + {rg}_{v} {bZ}_{W}\end{matrix} \\ \{ \begin{matrix}λ X = ( 1 - r ) ( 1 - g ) ( 1 - {b}_{v} ) {X}_{k} + r ( 1 - g ) ( 1 - {b}_{v} ) {X}_{r} + ( 1 - r ) g ( 1 - {b}_{v} ) {X}_{g} + \\ ( 1 - r ) ( 1 - g ) {b}_{v} {X}_{b} + ( 1 - r ) {gb}_{v} {X}_{c} + r ( 1 - g ) {b}_{v} {X}_{m} + rg ( 1 - {b}_{v} ) {X}_{y} + {rgb}_{v} {X}_{W} \\ λ Y = ( 1 - r ) ( 1 - g ) ( 1 - {b}_{v} ) {Y}_{k} + r ( 1 - g ) ( 1 - {b}_{v} ) {Y}_{r} + ( 1 - r ) g ( 1 - {b}_{v} ) {Y}_{g} + \\ ( 1 - r ) ( 1 - g ) {b}_{v} {Y}_{b} + ( 1 - r ) {gb}_{v} {Y}_{c} + r ( 1 - g ) {b}_{v} {Y}_{m} + rg ( 1 - {b}_{v} ) {Y}_{y} + {rgb}_{v} {Y}_{W} \\ λ Z = ( 1 - r ) ( 1 - g ) ( 1 - {b}_{v} ) {Z}_{k} + r ( 1 - g ) ( 1 - {b}_{v} ) {Z}_{r} + ( 1 - r ) g ( 1 - {b}_{v} ) {Z}_{g} + \\ ( 1 - r ) ( 1 - g ) {b}_{v} {Z}_{b} + ( 1 - r ) {gb}_{v} {Z}_{c} + r ( 1 - g ) {b}_{v} {Z}_{m} + rg ( 1 - {b}_{v} ) {Z}_{y} + {rgb}_{v} {Z}_{W}\end{matrix}$$

In above three sets of equations, XYZ is tristimulus value of the to-be-converted color and the values are known; parameters r, g, b represent three primary colors, and are unknown. r, g, b are power functions with driving values dᵣ, d_{g}, d_{b} as independent variables. The format of the power function is:

r=dᵣ^{γ}^{ᵣₚ}^{γ}^{_{pd}}, g=d_{g}^{γ}^{_{gp}}^{γ}^{_{pd}}, b=d₅^{γ}^{_{pd}}^{γ}^{_{pd}}, rᵥ=pᵥ^{γ}^{ᵣₚ}=dᵥ^{γ}^{ᵣₚ}^{γ}^{_{pd}}, gᵥ=pᵥ^{γ}^{_{gp}}=dᵥ^{γ}^{_{gp}} ^{γ}^{_{pd}}, bᵥ=pᵥ^{γ}^{_{bp}}=dᵥ^{γ}^{_{bp}}^{γ}^{_{pd}}

The exponents γ_{pd}γᵣₚ, γ_{pd}γ_{gp}, γ_{pd}γ_{bp} of the power functions are dependent on media characteristic and device; their values can be achieved by Liu's primaries damping equation and Liu's gray calibration equation using method of characterization.

In the equations, X_{w}Y_{w}Z_{w}, XₖYₖZₖ are measured tristimulus values of white and black point on display device. XᵣYᵣZᵣ, X_{g}Y_{g}Z_{g}, X_{b}Y_{b}Z_{b} are measured tristimulus values of primaries (red, green, blue) when dᵣ, d_{g}, d_{b} are maximum values;

X_{c}Y_{c}Z_{c}, XₘYₘZₘ, X_{y}Y_{y}Z_{y} are trisimulus values of cyan, magenta and yellow based on driving values (d_{g}+d_{b}), (dᵣ+d_{b}), (d_{g}+dᵣ) when dᵣ, d_{g}, d_{b} are maximum values. Parameter rᵥ, gᵥ, bᵥ are called gray core values. Its definition is: when mixing three primaries to produce a color, the primary with the least value mixed with other two primaries produces gray component of the color. The color with the least value can be seen as gray core of the color. If primary r (red) is the one with the least value amongst r, g, b, then r becomes the gray core of the color, and we name it rᵥ. Similarly, if primary with the least value is g (or b) in a certain color, we use gᵥ, (or bᵥ) to represent its gray core values. Gray core parameter and r, g, b have the same function expression. The only difference between the two is: gray core parameter is the primary with the least value among three primaries; it is calculated based on value of gray component in color XYZ; the calculated known value is passed to this equation; each transformation equation contains only one gray core parameter. If the value of gray in XYZis referred to as pᵥ, the value of pᵥ is proportional to the value of gray core parameter. The method to calculate the pᵥ will be discussed later.

Each transformation equation has three unknown variables: the two primary parameters other than gray core parameter and color appearance keeping parameter λ. λ is an important parameter- keeping color appearance parameter. With the help of parameter λ and gray core values, the driving value dᵣ, d_{g}, d_{b} obtained after conversion can reproduce the hue of color XYZ, which can't be accomplished using linear transformation equation. Parameter λ is also an interface parameter. It keeps the hue and chromaticity characteristics of the reproduced color when system γ is not 1.

As mentioned above, the image color obtained with this equation could be dim as the display device itself has nonlinear characteristics of photoelectric transformation. Therefore, based on this equation, a corresponding equation with gamma correction function needs to be created.

2. XYZ—rᵥ′gᵥ′bᵥ′—dᵣd_{g}d_{b} Gamma Correction Equation Based on New Principle

The main function of gamma correction equation is to obtain anti-gamma value X′Y′Z′of the known color XYZ and the driving value dᵣd_{g}d_{b} related with X′Y′Z′, so the image can be represented on the display device in proper tone. The gamma correction equation XYZ—rᵥ′gᵥ′bᵥ′—dᵣd_{g}d_{b} adds the gamma correction function to XYZ—rᵥ′gᵥ′bᵥ′—dᵣd_{g}d_{b} color space transform equation. The gamma correction is unavoidable as long as the display device is not ideally linear. Like XYZ—rᵥgᵥbᵥ—dᵣd_{g}d_{b} color space transform equation, gamma correction equation also has three similar formats rᵥgb, rgᵥb and rgbᵥ, and they are quadratic equations as well. The three equations are listed as below:

$$\{ \begin{matrix}λ X = ( 1 - {r}_{v}^{′} ) ( 1 - g ) ( 1 - b ) {X}_{k} + {r}_{v}^{′} ( 1 - g ) ( 1 - b ) {X}_{r} + ( 1 - {r}_{v}^{′} ) g ( 1 - b ) {X}_{g} + \\ ( 1 - {r}_{v}^{′} ) ( 1 - g ) {bX}_{b} + ( 1 - {r}_{v}^{′} ) {gbX}_{c} + {r}_{v}^{′} ( 1 - g ) {bX}_{m} + {r}_{v}^{′} g ( 1 - b ) {X}_{y} + {r}_{v}^{′} {gbX}_{W} \\ λ Y = ( 1 - {r}_{v}^{′} ) ( 1 - g ) ( 1 - b ) {Y}_{k} + {r}_{v}^{′} ( 1 - g ) ( 1 - b ) {Y}_{r} + ( 1 - {r}_{v}^{′} ) g ( 1 - b ) {Y}_{g} + \\ ( 1 - {r}_{v}^{′} ) ( 1 - g ) {bY}_{b} + ( 1 - {r}_{v}^{′} ) {gbY}_{c} + {r}_{v}^{′} ( 1 - g ) {bY}_{m} + {r}_{v}^{′} g ( 1 - b ) {Y}_{y} + {r}_{v}^{′} {gbY}_{W} \\ λ Z = ( 1 - {r}_{v}^{′} ) ( 1 - g ) ( 1 - b ) {Z}_{k} + {r}_{v}^{′} ( 1 - g ) ( 1 - b ) {Z}_{r} + ( 1 - {r}_{v}^{′} ) g ( 1 - b ) {Z}_{g} + \\ ( 1 - {r}_{v}^{′} ) ( 1 - g ) {bZ}_{b} + ( 1 - {r}_{v}^{′} ) {gbZ}_{c} + {r}_{v}^{′} ( 1 - g ) {bZ}_{m} + {r}_{v}^{′} g ( 1 - b ) {Z}_{y} + {r}_{v}^{′} {gbZ}_{W}\end{matrix} \\ \{ \begin{matrix}λ X = ( 1 - r ) ( 1 - {g}_{v}^{′} ) ( 1 - b ) {X}_{k} + r ( 1 - {g}_{v}^{′} ) ( 1 - b ) {X}_{r} + ( 1 - r ) {g}_{v}^{′} ( 1 - b ) {X}_{g} + \\ ( 1 - r ) ( 1 - {g}_{v}^{′} ) {bX}_{b} + ( 1 - r ) {g}_{v}^{′} {bX}_{c} + r ( 1 - {g}_{v}^{′} ) {bX}_{m} + {rg}_{v}^{′} ( 1 - b ) {X}_{y} + {rg}_{v}^{′} {bX}_{W} \\ λ Y = ( 1 - r ) ( 1 - {g}_{v}^{′} ) ( 1 - b ) {Y}_{k} + r ( 1 - {g}_{v}^{′} ) ( 1 - b ) {Y}_{r} + ( 1 - r ) {g}_{v}^{′} ( 1 - b ) {Y}_{g} + \\ ( 1 - r ) ( 1 - {g}_{v}^{′} ) {bY}_{b} + ( 1 - r ) {g}_{v}^{′} {bY}_{c} + r ( 1 - {g}_{v}^{′} ) {bY}_{m} + {rg}_{v}^{′} ( 1 - b ) {Y}_{y} + {rg}_{v}^{′} {bY}_{W} \\ λ Z = ( 1 - r ) ( 1 - {g}_{v}^{′} ) ( 1 - b ) {Z}_{k} + r ( 1 - {g}_{v}^{′} ) ( 1 - b ) {Z}_{r} + ( 1 - r ) {g}_{v}^{′} ( 1 - b ) {Z}_{g} + \\ ( 1 - r ) ( 1 - {g}_{v}^{′} ) {bZ}_{b} + ( 1 - r ) {g}_{v}^{′} {bZ}_{c} + r ( 1 - {g}_{v}^{′} ) {bZ}_{m} + {rg}_{v}^{′} ( 1 - b ) {Z}_{y} + {rg}_{v}^{′} {bZ}_{W}\end{matrix} \\ \{ \begin{matrix}λ X = ( 1 - r ) ( 1 - g ) ( 1 - {b}_{v}^{′} ) {X}_{k} + r ( 1 - g ) ( 1 - {b}_{v}^{′} ) {X}_{r} + ( 1 - r ) g ( 1 - {b}_{v}^{′} ) {X}_{g} + \\ ( 1 - r ) ( 1 - g ) {b}_{v}^{′} {X}_{b} + ( 1 - r ) {gb}_{v}^{′} {X}_{c} + r ( 1 - g ) {b}_{v}^{′} {X}_{m} + rg ( 1 - {b}_{v}^{′} ) {X}_{y} + {rgb}_{v}^{′} {X}_{W} \\ λ Y = ( 1 - r ) ( 1 - g ) ( 1 - {b}_{v}^{′} ) {Y}_{k} + r ( 1 - g ) ( 1 - {b}_{v}^{′} ) {Y}_{r} + ( 1 - r ) g ( 1 - {b}_{v}^{′} ) {Y}_{g} + \\ ( 1 - r ) ( 1 - g ) {b}_{v}^{′} {Y}_{b} + ( 1 - r ) {gb}_{v}^{′} {Y}_{c} + r ( 1 - g ) {b}_{v}^{′} {Y}_{m} + rg ( 1 - {b}_{v}^{′} ) {Y}_{y} + {rgb}_{v}^{′} {Y}_{W} \\ λ Z = ( 1 - r ) ( 1 - g ) ( 1 - {b}_{v}^{′} ) {Z}_{k} + r ( 1 - g ) ( 1 - {b}_{v}^{′} ) {Z}_{r} + ( 1 - r ) g ( 1 - {b}_{v}^{′} ) {Z}_{g} + \\ ( 1 - r ) ( 1 - g ) {b}_{v}^{′} {Z}_{b} + ( 1 - r ) {gb}_{v}^{′} {Z}_{c} + r ( 1 - g ) {b}_{v}^{′} {Z}_{m} + rg ( 1 - {b}_{v}^{′} ) {Z}_{y} + {rgb}_{v}^{′} {Z}_{W}\end{matrix}$$

Compare above three “gamma correction equations” and three “XYZ—rᵥgᵥbᵥ—dᵣd_{g}d_{b} color space transform equations”, we see their difference is the two sets of parameters: rᵥ, gᵥ, bᵥ and rᵥ′, gᵥ′, bᵥ′. In XYZ—rᵥ′gᵥ′bᵥ′—dᵣd_{g}d_{b} gamma correction equation, rᵥ′, gᵥ′, bᵥ′ are anti-gamma mapping values of gray core rᵥ, gᵥ, bᵥ; while rest of variables and constant symbols are same. Now you may guess: gamma correction is made possible by changing gray core values rᵥ, gᵥ, bᵥ to rᵥ′, gᵥ′, bᵥ′. That's exactly what it is. Their relationship is:

rᵥ′=(pᵥ)^{yγ}^{ᵣₚ}=dᵥ^{y(γ}^{ᵣₚ}^{γ}^{_{pd}}⁾, gᵥ′=(pᵥ)^{yγ}^{_{gp}}=dᵥ^{y(γ}^{_{gp}}^{γ}^{_{pd}}⁾, bᵥ′=(pᵥ)^{yγ}^{_{gp}}=dᵥ^{y(γ}^{_{bp}}^{γ}^{_{pd}}⁾

r=dᵣ^{y(γ}^{ᵣₚ}^{γ}^{_{pd}}⁾, g=d_{g}^{y(γ}^{_{gp}}^{γ}^{_{pd}}⁾, b=d_{b}^{y(γ}^{_{bp}}^{γ}^{_{pd}}⁾

dᵣ=r^{γ}^{ᵣₚ}^{γ}^{_{pd}}, d_{g}=r^{γ}^{_{gp}}^{γ}^{_{pd}}, d_{b}=r^{γ}^{_{bp}}^{γ}^{_{pd}}

In above gray core function rᵥ′, gᵥ′, bᵥ′, the parameter pᵥ is the previously mentioned gray value parameter, which represents the amount of gray in XYZ. Both rᵥ, gᵥ, bᵥ and rᵥ′, gᵥ′, bᵥ′ are functions using driving value dᵥ as independent variable. The exponents of power function are reciprocals of each other. Obviously, this is a new gamma correction method. Primary component values rgb are referred to as the display primary colors directly related to the characteristic of the display device.

Gray core values rᵥ′, gᵥ′, bᵥ′ reflect the principle to preferentially ensure gray component exact during color reproduction. Co/or appearance keeping parameter λ satisfies the conditions of keeping chromaticity fidelity. It also satisfies conditions for proportional brightness and equal contrast. The value of the gamma parameters γᵣₚγ_{pd}, γ_{gp}γ_{pd}, γ_{bp}γ_{pd} need to be calculated using the method of characteristics which will be discussed later.

3. Primaries Clamping Equation and the Parameter Model Derived from this Equation

Application of equation:

The ‘red- shift effect' in media is a special form of Doppler Effect. It could happen to the images sent from aircraft, radio transmission vehicles or medical images. Colors produced by nonlinear media could be affected by ‘red shift effect’ too. Due to the existence of ‘red shift effect, the hue of the primary color doesn't remain the same when driving value changes. When produce a color using primaries rgb, the variation of the primary's hue breaks the independent characteristic of the primary color. If we make the driving value of a certain primary color increasing from 0 to 1 with equal step, then measure the color each time driving value changes, we can find the chromaticity coordinates of these colors change continuously. Gray core values rᵥ, gᵥ, bᵥ and rᵥ′, gᵥ′, bᵥ′ are parameters calculated indirectly based on Liu's primaries clamping equation. They all got the channel independence characteristic. The format of the power function rᵥ, gᵥ, bᵥ has been discussed earlier. The exponent of the power function is constant value dependent on device and media, the specific value must be determined based on actual measured data in characterization. Use Liu's primaries clamping equation and parameter model derived from the equation as tool to give “channel independent characteristics” to rᵥ, gᵥ, bᵥ, rᵥ′, gᵥ′, bᵥ′. Then with the help of rᵥ, gᵥ, bᵥ, rᵥ′, gᵥ′, bᵥ′ and color appearance keeping parameter λ, primary component rgb in color space transformation equation XYZ—rᵥgᵥbᵥ—dᵣd_{g}d_{b} and gamma correction equation XYZ—rᵥ′gᵥ′bᵥ′—dᵣd_{g}d_{b} has also been given the “channel independent characteristics”.

The format of the clamping equation, its derivative models and meanings:

Display every color of primaries scale on display, given every scale has 41 levels, every time a driving value is inputted, measure tristimulus of this level using spectrophotometer; repeat this process and we will end up with three groups of data, a total of 123 sets of primary tristimulus values. These data need to be processed using Liu's primaries clamping equation. The general form of the equation is:

$$\{ \begin{matrix}λ X = ( 1 - {a}_{t} ) {X}_{k} + {a}_{t} {X}_{s} \\ λ {Y}_{t} = ( 1 - {a}_{t} ) {Y}_{k} + {a}_{t} {Y}_{s} \\ λ Z = ( 1 - {a}_{t} ) {Z}_{k} + {a}_{t} {Z}_{s}\end{matrix}$$

In above equation: X and Z are two of the three tristimulus values X, Y, Z measured on display device. Xₖ, Yₖ, Zₖ are screen color when driving value=0; Xₛ, Yₛ, Zₛ are tristimulus values of primaries measured on the screen when driving value=255.

Parameter λ, aₜ, Yₜ are variable parameters; λ is called color appearance keeping parameter, aₜ is clamping primary value; Yₜ is damping brightness of primary.

According to above equation, when driving value is 255, aₜ=1; when driving value is 0, aₜ=0; the range is 0≦aₜ≦1.

When driving value is 255, the primary component value aₜ is the unit primary component value. The function of primaries clamping equation:

If let the primary hue be the reference hue of the primary color when the driving value equals 255, the primary value aₜ determined by the primaries clamping equation is same as the reference hue, the brightness is λYₜ. The color represented by aₜ is λX, λYₜ, λZ instead of the measured tristimulus X, Y, Z, the color represented by the primary value aₜ is same as the hue of the unit primary. The following are the three parameter expressions derived based on Liu's primaries clamping equation:

$${Y}_{t} = \frac{( {Y}_{s} - {Y}_{k} ) \cdot \{ \begin{matrix}X [ {Y}_{k} ( {Z}_{s} - {Z}_{k} ) - {Z}_{k} ( {Y}_{s} - {Y}_{k} ) ] - \\ Z [ {Y}_{k} ( {X}_{s} - {X}_{k} ) - {X}_{k} ( {Y}_{s} - {Y}_{k} ) ]\end{matrix} \}}{\begin{matrix}( {X}_{s} - {X}_{k} ) [ {Y}_{k} ( {Z}_{s} - {Z}_{k} ) - {Z}_{k} ( {Y}_{s} - {Y}_{k} ) ] - \\ ( {Z}_{s} - {Z}_{k} ) [ {Y}_{k} ( {X}_{s} - {X}_{k} ) - {X}_{k} ( {Y}_{s} - {Y}_{k} ) ]\end{matrix}}$$

$$λ = \frac{{Y}_{k} ( {Z}_{s} - {Z}_{k} ) - {Z}_{k} ( {Y}_{s} - {Y}_{k} )}{{Y}_{t} ( {Z}_{s} - {Z}_{k} ) - Z ( {Y}_{s} - {Y}_{k} )}$$

$${a}_{t} = \frac{λ {Y}_{t} - {Y}_{k}}{{Y}_{s} - {Y}_{k}}$$

Beneficial effects of Liu's primaries clamping equation and its derived parameters: The formula to calculate color clamp brightness Yₜ can be derived from the primaries clamping equation. Yₜ is the required value to calculate clamp primary value aₜ. The color appearance keeping parameter λ multiplied by clamp brightness Yₜ will give out the brightness value of clamp primary value aₜ. Main function of parameter λ is to distil the red-shift component from measured XYZ, and show the relative red-shift value of primary color at a certain wavelength. You will see other uses of λ in following pages. This invention refers the primary equation with above format as Liu's primary clamping equation.

4. The New Mathematical Model to Calculate the Reference Primary Value

Application of the model:

After normalization by clamping equation, clamping primary value, aₜ, becomes a hue independent color whose brightness value is λYₜ. Although Yₜ is a known value which can be described by model, the fine characteristic of primary value aₜ are not good enough, the reference primary value a derived from aₜ can let the primary parameter have better three dimension characteristic: static hue, static chromaticity coordinates ratio and remove the primary brightness shift caused by red-shift effect.

The format of reference primary value model:

Below is the universal format of reference primary value:

$$a = \frac{{Y}_{t} - {Y}_{k}}{{Y}_{s} - {Y}_{k}}$$

In above formula, parameter a is referred to as reference primary value. For convenience, it is referred to as primary value, and Yₜ is referred to as clamping brightness. The model to calculate primaries r, g, b is:

$$r = \frac{{Y}_{tr} - {Y}_{k}}{{Y}_{r} - {Y}_{k}} , \\ g = \frac{{Y}_{tg} - {Y}_{k}}{{Y}_{g} - {Y}_{k}} , \\ b = \frac{{Y}_{tb} - {Y}_{k}}{{Y}_{b} - {Y}_{k}}$$

In above formula, r, g, b are referred to as the reference primary value of red, green, blue; Yᵣ, Y_{g}, Y_{b} are the actual brightness value measured on the screen when digital driving values are dᵣ=255, d_{g}=255, d_{b}=255; Yₜᵣ, Y_{tg}, Y_{tb} are the clamp brightness values of the three primaries. Beneficial effects of primary value model:

reference primary value a defined by primary value model has following characteristics: the reference primary r, g, b and their unit primary have the same hue; its colorfulness are determined by the measured X, Zvalue and its brightness equals clamping brightness value Yₜ, , measured brightness Y contains red-shift component, so not brightness of primary value a. Yₜ is the ‘clean’ primary brightness of primary value. Liu's primary value model can obtain ‘clean’ primary value, which space coordinates fixed, and give three primaries nice independent characteristic. This invention name the new model to get primary value model as Liu's reference primary value model.

5. Gray Calibration Equation

Application of the equation:

Gray calibration equation can separate the “visual adapted neutral gray to white point” into three primary components. For the digital images displayed based on the three primary colors, it is not sufficient to only keep primary's channel independence in mixing color, the ‘space independence’ of the primary color also needs to be addressed. The conventional linear equation based on the additive color principle can't address the color distortion problem caused by space non-independence. As mentioned above, XYZ—rᵥgᵥbᵥ—dᵣd_{g}d_{b} color space transformation equation is a non-linear equation, and it can resolve the ‘space non-independent’ problem. But gray core parameters rᵥ, gᵥ, bᵥin the equation are device and media dependent, which requires the use of gray calibration equation as a tool to calibrate the gray core parameter rᵥ, gᵥ, bᵥ using a tristimulus array from special gray scale as reference data. The special gray scale is “visual adapted neutral gray to white point”. This can not only give rᵥ, bᵥ, bᵥ basic characteristic of the reference primary value, but also make rᵥ, gᵥ, bᵥ have the relative independence in whole color space. The three primaries rᵥ, gᵥ, bᵥ have another important characteristic: the gray produced by the combination of these three primaries are the “visual adapted neutral gray to white point”, it takes into account the observation condition.

The format of the gray calibration equation:

$$\{ \begin{matrix}X = ( 1 - {r}_{x} ) ( 1 - {g}_{x} ) ( 1 - {b}_{x} ) {X}_{k} + {r}_{x} ( 1 - {g}_{x} ) ( 1 - {b}_{x} ) {X}_{r} + ( 1 - {r}_{x} ) {g}_{x} ( 1 - {b}_{x} ) {X}_{g} + \\ ( 1 - {r}_{x} ) ( 1 - {g}_{x} ) {b}_{x} {X}_{b} + ( 1 - {r}_{x} ) {g}_{x} {b}_{x} {X}_{c} + {r}_{x} ( 1 - {g}_{x} ) {b}_{x} {X}_{m} + {r}_{x} {g}_{x} ( 1 - {b}_{x} ) {X}_{y} + {r}_{x} {g}_{x} {b}_{x} {X}_{w} \\ Y = ( 1 - {r}_{y} ) ( 1 - {g}_{y} ) ( 1 - {b}_{y} ) {Y}_{k} + {r}_{y} ( 1 - {g}_{y} ) ( 1 - {b}_{y} ) {Y}_{r} + ( 1 - {r}_{y} ) {g}_{y} ( 1 - {b}_{y} ) {Y}_{g} + \\ ( 1 - {r}_{y} ) ( 1 - {g}_{y} ) {b}_{y} {Y}_{b} + ( 1 - {r}_{y} ) {g}_{y} {b}_{y} {Y}_{c} + {r}_{y} ( 1 - {g}_{y} ) {b}_{y} {Y}_{m} + {r}_{y} {g}_{y} ( 1 - {b}_{y} ) {Y}_{y} + {r}_{y} {g}_{y} {b}_{y} {Y}_{w} \\ Z = ( 1 - {r}_{z} ) ( 1 - {g}_{z} ) ( 1 - {b}_{z} ) {Z}_{k} + {r}_{z} ( 1 - {g}_{z} ) ( 1 - {b}_{z} ) {Z}_{r} + ( 1 - {r}_{z} ) {g}_{z} ( 1 - {b}_{z} ) {Z}_{g} + \\ ( 1 - {r}_{z} ) ( 1 - {g}_{z} ) {b}_{z} {Z}_{b} + ( 1 - {r}_{z} ) {g}_{z} {b}_{z} {Z}_{c} + {r}_{z} ( 1 - {g}_{z} ) {b}_{z} {Z}_{m} + {r}_{z} {g}_{z} ( 1 - {b}_{z} ) {Y}_{y} + {r}_{z} {g}_{z} {b}_{z} {Z}_{w}\end{matrix}$$

In above equation: X, Y, Z are tristimulus values of the color to be matched; X_{w}Y_{w}Z_{w}, XₖYₖZₖ are measured tristimulus values of white and black points on the display; XᵣYᵣZᵣ, X_{g}Y_{g}Z_{g}, X_{b}Y_{b}Z_{b} are the measured tristimulus values of primaries given the driving value dᵣ, d_{g}, d_{b} are at maximum values. X_{c}, Y_{c}, Z_{c} are tristimulus values of secondary color cyan driven by (d_{g}+d_{b}) given d_{g}, d_{b} are at their maximum values;

Xₘ, Yₘ, Zₘ are tristimulus values of secondary color magenta driven by (dᵣ+d_{b}) given dᵣ, d_{b} are at their maximum values;

X_{y}, Y_{y}, Z_{y} are tristimulus values of secondary color yellow driven by (dᵣ+d_{g}) given dᵣ, d_{g} are at their maximum values.

The variable parameters rₓ, r_{y}, r_{z}, gₓ, g_{y}, g_{z}, bₓ, b_{y}, b_{z} on right side of equation are called channel primary component values. They are used to match tristimulus value X, Y, Z on the left side of the equation. From this perspective, the channel primary parameters have the ‘channel independent characteristics’. However, the channel primary parameters are not simple variables; they are functions of primary component value r, g and b. The formats of functions are:

rₓ=r^{γ}^{_{xy}}, r_{y}=r^{γ}^{_{y}}, r_{z}=r^{γ}^{_{z}}, gₓ=g^{γ}^{_{xy}}, g_{y}=g^{γ}^{_{xy}}, g_{z}=g^{γ}^{_{zy}}, bₓ=b^{γ}^{_{zb}}, b_{y}=b^{γ}^{_{yb}}, b_{z}=b^{γ}^{_{zb}}

In above functions, the reference primary value rgb is a common independent variable of channel primary component value function, which make the three independent channels XYZ cross-linked; parameter rgb has the characteristics of reference primary value , but also retains its ‘primary independence’. The channel primary independence doesn't change when rgb changes. It overcomes the mixing color chromatic aberration problem caused by channel and space non-independence of the conventional primary superposition linear equation.

Please note: primary parameter r, g, and b are the functions of driving parameter dᵣ, d_{g}, d_{b}. The functions are:

r=dᵣ^{γ}^{_{rd}}, g=d_{g}^{γ}^{_{gd}}, b=d_{b}^{ι}^{_{bd}}

Inverse solution above functions:

dᵣ=r^{yγ}^{ₙ}, d_{g}=r^{yγ}^{_{gd}}, d_{b}=r^{yγ}^{_{bd}}

In above function, the exponent is device and media dependent variable. They need to be solved using the method of characterization. In this invention this calibration equation is called Liu's gray calibration equation, and it can be resolved by using the iterative method.

6. A method to Characterize the Gray Calibration Equation

Application of the method:

In gray calibration equation, the power exponential values y_{XT}, y_{yT}, y_{ZT}, y_{xg}, y_{yg}, y_{zg}, y_{xb}, y_{yb}, y_{zb}, y_{rd}, y_{dg}, y_{bd} need to be solved using following characteristic method.

Procedures:

Step1. Adjust the monitor under the set observation condition and the fixed brightness condition, then adjust the signal amplitude of the three primaries RGB based on white field color temperature in accordance to manufacture regulation, so that the brightest white meet the color temperature benchmark requirement of reference white.

Step2. Display and measure the colors on primaries scale respectively using the set driving value dᵣᵢ,d_{gi},d_{bi} Character i is the levels of each primaries scale. On the scale there are 41 primary red, 41 primary green and 41 primary blue, 41 gray generated with same driving value (dᵣ+d_{g}+d_{b}); tristimulus values of black dots (on screen) generated by driving values dᵣ=0, d_{g}=0, d_{b}=0, tristimulus values of white points (on screen) generated by driving values dᵣ=255, d_{g}=255, d_{b}=255.

In addition, three secondary colors (dᵣ=255, d_{g}=255), (dᵣ=255, d_{b}=255), (d_{g}=255, d_{b}=255) also need to be displayed. In total there are 167 colors need to be displayed and their tristimulus values need to be measured. The input driving value d, requires normalization.

Step3. Calculated clamping brightness values Yₜᵣᵢ, Y_{tgi}, Y_{tbi} using clamping brightness model based on measured tristimulus values of primaries scale;

Step4. Calculate reference primary component value rᵢ, gᵢ, bᵢ using Liu's primaries equation based on clamping brightness values Yₜᵣᵢ, Y_{tgi}, Y_{tb};

Step 5. Calculate channel primary value of three primaries. Taking blue as an example: pass blue's 41 measured tristimulus values X_{bi}, Y_{bi}, Z_{bi} into following model, and get values of channel primary component value bₓᵢ, b_{yi}, b_{zi}.

bₓ=(X−Xₕ)/(X_{b}−Xₖ), b_{y}=(Y−Yₖ)/(Y_{b}−Yₖ), b_{z}=(Z−Zₕ)/(Z_{b}−Zₖ)

In above formula, bₓ, b_{y}, b_{z} represent channel primary component value of blue in channel X, Y, Z. For green, simply substitute character b with character g. For red, substitute character b with character r.

Step6. Perform curve fitting: RGB's reference primary array rᵢ, gᵢ, bᵢ as independent variables and channel primary array rₓᵢ, r_{yi}, r_{zi} as dependent variables; then we get functions of channel primary component values and their exponent values.

rₓ=r^{γ}^{ᵣₓ}, r_{y}=r^{γ}^{_{ry}}, r_{z}=r^{γ}^{_{rz}} gₓ=g^{γ}^{_{cx}}, g_{y}=g^{γ}^{_{xy}}, g_{z}=g^{γ}^{_{gz}} bₓ=b^{γ}^{_{bx}}, b_{y}=b^{γ}^{_{ty}}, b_{z}=b^{γ}^{_{tz}}

Step7. Perform curve fitting: RGB's reference primary array rᵢ, gᵢ, bᵢ as dependent variables, and corresponding driving value array dᵣᵢ, d_{gi}, d_{bi} as independent variables; then we get functions of primary component values and their exponent values.

r=dₜ^{γ}^{_{rd}}, g=d_{g}^{γ}^{_{gd}}, b=d_{b}^{γ}^{_{bd}}

Through these steps, all exponent values in above power functions can be solved, and characterization is done.

7. A Brightness Lightness—Chromaticity Segment Equation to Separate Color XYZ into Gray Component and Chromatic Component and its Usage

Application of the segment equation:

Color space transformation equation XYZ—rᵥgᵥbᵥ—dᵣd_{g}d_{b} and gamma correction equation XYZ—rᵥ′gᵥ′bᵥ′—dᵣd_{g}d_{b} contain gray core values bᵥ,gᵥ, rᵥ and rᵥ′, gᵥ′, bᵥ′. They are calculated based on a certain color's gray component value. In other words, they are calculated based on the color's gray component value pᵥ or pᵥ′. So, it is necessary to separate known color XYZinto gray component and chromatic component. The same situation also happens on image transmission device, for example, on television camcorder or digital camera which are sending end of color information, a color need to be converted into brightness signal and chromaticity signal of transmission or compression.

Please note when dealing with non-linear devices like monitors, current method, which creates brightness and chromaticity signal in YUV or YCᵣC_{b} space, cannot ensure ‘constant brightness principle’ of color television transmission, and can't guarantee brightness information is not affected by chromaticity information. Furthermore, after gamma correction, brightness information of image detail can't be satisfactory reproduced, especially colors close to displaying primary (e.g. blue) will show obvious chromatic aberration. This will not only affect display quality of the image detail, but also result in hue shift.

The brightness-chromaticity segment equation in this invention is a data transmission model; it can ensure the brightness doesn't get affected by chromaticity during the transmission. Even when chromaticity is no longer accurate, the hue of the color transferred can remain unchanged. This equation is a quadratic one, and can be simplified into simple algebraic expression and calculate the objective parameters accurately and effectively. This equation is called Liu's segment equation in the invention.

Format of Liu's segment equation:

Similar to XYZ—rᵥgᵥbᵥ—dᵣd_{g}d_{b} color space transformation equation, Liu's segment equation has three formats, rᵥgb,rgᵥb,rgbᵥ; the three equations segment the to-be-converted color space into three segments:

$$\{ \begin{matrix}X = [ ( 1 - g ) ( 1 - b ) {X}_{k} + g ( 1 - b ) {X}_{g} + b ( 1 - g ) {X}_{b} + {gbX}_{c} ] \cdot ( 1 - {p}_{v} ) + {p}_{v} \cdot {X}_{w} \\ Y = [ ( 1 - g ) ( 1 - b ) {Y}_{k} + g ( 1 - b ) {Y}_{g} + b ( 1 - g ) {Y}_{b} + {gbY}_{c} ] \cdot ( 1 - {p}_{v} ) + {p}_{v} \cdot {Y}_{w} \\ Z = [ ( 1 - g ) ( 1 - b ) {Z}_{k} + g ( 1 - b ) {Z}_{g} + b ( 1 - g ) {Z}_{b} + {gbZ}_{c} ] \cdot ( 1 - {p}_{v} ) + {p}_{v} \cdot {Z}_{w}\end{matrix} \\ \{ \begin{matrix}X = [ ( 1 - r ) ( 1 - b ) {X}_{k} + r ( 1 - b ) {X}_{r} + b ( 1 - r ) {X}_{b} + {rbX}_{m} ] \cdot ( 1 - {p}_{v} ) + {p}_{v} \cdot {X}_{w} \\ Y = [ ( 1 - r ) ( 1 - b ) {Y}_{k} + r ( 1 - b ) {Y}_{r} + b ( 1 - r ) {Y}_{b} + {rbY}_{m} ] \cdot ( 1 - {p}_{v} ) + {p}_{v} \cdot {Y}_{w} \\ Z = [ ( 1 - r ) ( 1 - b ) {Z}_{k} + r ( 1 - b ) {Z}_{r} + b ( 1 - r ) {Z}_{b} + {rbZ}_{m} ] \cdot ( 1 - {p}_{v} ) + {p}_{v} \cdot {Z}_{w}\end{matrix} \\ \{ \begin{matrix}X = [ ( 1 - r ) ( 1 - g ) {X}_{k} + r ( 1 - g ) {X}_{r} + g ( 1 - r ) {X}_{g} + {rgX}_{y} ] \cdot ( 1 - {p}_{v} ) + {p}_{v} \cdot {X}_{w} \\ Y = [ ( 1 - r ) ( 1 - g ) {Y}_{k} + r ( 1 - g ) {Y}_{r} + g ( 1 - r ) {Y}_{g} + {rgY}_{y} ] \cdot ( 1 - {p}_{v} ) + {p}_{v} \cdot {Y}_{w} \\ Z = [ ( 1 - r ) ( 1 - g ) {Z}_{k} + r ( 1 - g ) {Z}_{r} + g ( 1 - r ) {Z}_{g} + {rgZ}_{y} ] \cdot ( 1 - {p}_{v} ) + {p}_{v} \cdot {Z}_{w}\end{matrix}$$

In above equation, pᵥ is gray component value in color XYZ; primaries value rgb are unknown variables. Please note in each equation there are two ‘primary component’ parameters and one ‘gray component’ parameter. When the value of pᵥ floats from 0 to 1, pᵥX_{w}, pᵥY_{w}, pᵥZ_{w} actually create a ‘visual adaptation gray scale to white point’. The proportion of the chromatic components is (1−pᵥ).

Use of Liu's segment equation:

First of all, divide input color XYZ by white point tristimulus X_{w}, Y_{w}, Z_{w}, then choose suitable format of segment equation according to calibrated XYZ. The rule is:

if Xis the smallest value in tristimulus X, Y, Z, use rgb segment equation to segregate color XYZ;

if Yis the smallest value in tristimulus X, Y, Z, use rgb segment equation to segregate color XYZ;

if Z is the smallest value in tristimulus X, Y, Z, use rgb—segment equation to segregate color XYZ;

8. A Method to Create ‘Visual Adapted Neutral Gray Scale to White Point’

Application of the method:

In order to pass gray core value rᵥ, gᵥ, bᵥ dynamically to XYZ—rᵥgᵥbᵥ—dᵣd_{g}d_{b} color space transformation equation, a ‘visual adapted gray scale to white point’ must be created. It will be used as a tool to create mathematical model to calculate ‘gray core’ values rᵥ, gᵥ, bᵥ, rᵥ′, gᵥ′, bᵥ′.

Procedures:

Step 1, when the monitor is adjusted correctly, given dᵣᵢ=d_{gi}=d_{bi}, use drive value sets [0,0,0], [4,4,4], [8,8,8], [12,12,12], . . . , [255,255,255] to display 41 gray on monitor respectively, and measure tristimulus values of 41 displayed gray; the result is tristimulus value array [Xᵢ, Yᵢ, Zᵢ].

Step 2, calculate chromaticity coordinate of white point:

Suppose driving value array [255, 255, 255] produces a white balance color, and its measured tristimulus values are X_{w}, Y_{w}, Z_{w}, and chromaticity coordinates of white point on screen are x_{w},y_{w}, then the formula is:

Xᵥᵢ=(x_{w}/y_{w})·Yᵢ, Yᵥᵢ=Yᵢ, Zᵥᵢ=(1−x_{w}−y_{w})·Yᵢ

Step 3, based on chromaticity coordinates of white point x_{w}, y_{w} and measured tristimulus Yᵢ, calculate white adaptation gray scale's tristimulus Yᵥᵢ, Zᵥᵢ, Zᵥᵢ

Xᵥᵢ=(x_{w}/y_{w})·Yᵢ, Yᵥᵢ=Yᵢ, Zᵥᵢ=(1−x_{w}−y_{w})·Yᵢ

9. The Method to Create and Characterize Gray Core Functions

Application of the method: Solve the exponent value in gray core power function and find solution to calculate gray core value rᵥ′, gᵥ′, bᵥ′ based on gray component value pᵥ′. This method can improve algorithm efficiency and ensure correct reproduction of gray tone.

Procedures of the method:

Steps to solve gray core function rᵥᵢ gᵥᵢ bᵥ

Step 1, Calculate gray component value array [pᵥᵢ]: use the model below to calculate gray component value array [pᵥᵢ] based on the 41 brightness value Yᵥᵢ on the gray scale, which are synthesized by the three primary colors;

pᵥ=(Yᵥ−Yₖ)/(Y_{w}−Yₖ)

Step 2, Match tristimulus values Xᵥᵢ, Yᵥᵢ, Zᵥᵢ of ‘visual adapted gray scale’ to three primary array [rᵥᵢ], [gᵥᵢ,], [bᵥᵢ] using Liu's gray calibration equation, the result are values of three primary array [rᵥᵢ ], [gᵥᵢ ], [bᵥᵢ] which are originally unknown variables in Liu's gray calibration equation.

Step 3, Represent the three primary rᵥ, gᵥ, bᵥ as the function of gray component pᵥ: let [pᵥᵢ] be array of independent variable, and [rᵥᵢ], [gᵥᵢ], [bᵥᵢ] as array of dependent variable respectively, perform curve fitting to get the functions of rᵥ, gᵥ, b_{y} as follows:

rᵥ=pᵥ^{γ}^{ᵣₚ}gᵥ=pᵥ^{γ}^{ₓₚ}, bᵥ=pᵥ^{γ}^{_{bp}} then: pᵥ=rᵥ^{yγ}^{_{rd}}, pᵥ=gᵥ^{yγ}^{ᵣₚ}, pᵥ=bᵥ^{yγ}^{_{bp}}

Step 4, Format gray driving values dᵥ=dᵣ=d_{g}=d_{b} into function with gray core rᵥ, gᵥ, bᵥ as independent variables:

First use gray color value [pᵥᵢ] as array of dependent variable, and gray driving value array [dᵥᵢ] as array of independent variable, do fitting for power function; the result is function of gray component value pᵥ:

pᵥ=dᵥ^{γ}^{_{pd}}, then: dᵥ=pᵥ^{yγ}^{_{pd}}

For ‘visual adapted gray scale to white point’, the relationship is:

dᵥ=pᵥ^{yγ}^{_{pd}}=(rᵥ^{yγ}^{_{rd}})^{yγ}^{_{pc}}=rᵥ^{y(γ}^{ᵣₚ}^{γ}^{_{pd}}⁾, dᵥ=pᵥ^{yγ}^{_{pd}}=(gᵥ^{yγ}^{_{pd}}^{)yγ}^{_{pd}}=gᵥ^{y(γ}^{_{gd}}^{γ}^{_{pd}}⁾

dᵥ=pᵥ^{yγ}^{_{pd}}=(bᵥ^{yγ}^{_{dp}}^{)yγ}^{_{pd}}=bᵥ^{y(γ}^{_{bp}}^{γ}^{_{pd}}⁰

Step 5, Extend format of gray core power function to primary component values r, g, b:

From above derivation, we can see gray is the status when three primaries strike balance, and at the moment gray driving value dᵥ=dᵣ=d_{g}=d_{b}. When matching non-white light with three primaries, primaries will lose balance, thus the resulting color is co/orfu/instead of white. Reason is that gray core actually has the least value among three primaries. So we can extend function rᵥ, gᵥ, bᵥ band gray driving value function dᵥ to a general format. In XYZ—rᵥgᵥbᵥ—dᵣd_{g}d_{b} color space transformation equation, parameters r,g,b and dᵣd_{g}, d_{b} have following function formats:

r=dᵣ^{γ}^{_{rc}}^{γ}^{_{pd}}, g=d_{g}^{γ}^{_{gp}}^{γ}^{_{pd}}, b=d_{d}^{γ}^{_{bp}}^{γ}^{_{pd}}, dᵣ=r^{γ(γ}^{ᵣₚ}^{γ}_is pd⁾, d_{g}=r^{y(γ}^{_{gd}}^{γ}^{_{pd}}⁾, d_{b}=r^{y(γ}^{_{bp}}^{γ}^{_{pd}}⁾

Steps to solve gray core function rᵥ′, gᵥ′, bᵥ′:

Step 1, Perform gamma correction for parameter pᵥ: p_{d}′=dᵥ^{yγ}^{_{pd}}=pᵥ^{yγ}^{²}^{_{pd}}

Step 2, Represent gray core values rᵥ′, gᵥ′, bᵥ′ as function of Pv

According to functions of rᵥ, b_{y}, bᵥ, we can get function rᵥ′, gᵥ′, bᵥ′ (dᵥ is independent variable):

rᵥ′=dᵥ^{y(γ}^{ᵣₚ}^{_{pd}}⁾, gᵥ′=dᵥ^{y(γ}^{_{dp}}^{_{pd}}⁾

and as pᵥ′=dᵥ^{yγ}^{_{pd}}

so rᵥ′=dᵥ^{y(γ}^{ᵣₚ}^{γ}^{_{pd}}⁾=(pᵥ′)^{yγ}^{ᵣₚ}, g′=dᵥ^{y(γ}^{_{gp}}^{γ}^{_{pd}}⁽=(pᵥ′)^{yγ}^{_{gp}}, bᵥ′=dᵥ^{y(γ}^{_{dp}}^{γ}^{_{pd}}⁾=(pᵥ′)^{yγ}^{_{bp}}

Step 3, Extend format of gray core power function to primary component values r, g, b: From above derivation, we can see gray is the status when three primaries strike balance, and at the moment gray driving value dᵥ=dᵣ=d_{g}=d_{b}. When matching non-white light with three primaries, primaries will lose balance, thus the resulting color is co/orfu/instead of white. Reason is that gray core actually has the least value among three primaries. So we can extend function rᵥ, gᵥ, bᵥ and gray driving value function dᵥ to a general format. In XYZ—rᵥgᵥbᵥ—dᵣd_{g}d_{b} color space transformation equation, parameters r,g,b and dᵣ, d_{g}, d_{b} have following function formats:

r=dᵣ^{γ}^{ᵣₚ}^{γ}^{_{pd}}, g=d_{g}^{γ}^{_{gp}}^{γ}^{_{pd}}, b=d_{b}^{γ}^{_{bp}}^{γ}^{_{pd}}, dᵣ=r^{y(γ}^{ᵣₚ}^{γ}^{_{pd}}⁾, d_{g}=r^{y(γ}^{_{gp}}^{γ}^{_{pd}}⁾, d_{b}=r^{y(γ}^{_{bp}}^{γ}^{_{pd}}⁾

10. The Nonlinear Method to Generate Brightness and Chromatic Signal

Application of the method:

TV images from video camera or color images from digital camera need to be transmitted to receiving end. Traditional method is based on Howells' primary transmission concept: brightness—chromatic difference separation is done in YUV or YCᵣC_{b} color space. After gamma correction, primary color voltage generates brightness and chromatic difference voltage signal to transmit image. This method is simple; however display system is nonlinear, which breaks color television's constant luminance principle and damage quality of displayed image. SMPTE standard urge all camera manufacturers to install a nonlinear conversion circuit designed according to the mathematical precision. In order to resolve this problem, this invention introduce a new method to generate brightness and chromatic difference information, and it can be used as mathematical and colorimetric principles when design nonlinear converting circuit for cameras. It can also be used to generate JPEG files in computer graphic field.

Write a standard matrix equation to convert the three primaries signal into standard tristimulus. Take the PAL-D system as example, the matrix equation can be found in related standards as below:

$$[ \begin{matrix}X \\ Y \\ Z\end{matrix} ] = [ \begin{matrix}0.4469 & 0.3197 & 0.1847 \\ 0.2421 & 0.6855 & 0.0724 \\ 0.0028 & 0.0934 & 0.9909\end{matrix} ] [ \begin{matrix}R \\ G \\ B\end{matrix} ]$$

The nonlinear method to generate brightness and chromatic difference signal is not based on voltage of primary color. They are generated based on standard tristimulus value of three primaries signal at camera side. This is because color signal transmission based on tristimulus can be widely used on different type of monitors. The standard tristimulus are same as the PCS color space in color management. The method using three primaries voltage can't satisfy the requirement of ‘making both current and future's monitors have the same chromaticity’. Steps to generate brightness and color difference signal is as following:

Step 1, As to color of camera side, put its three primaries' voltage signal RGB into above standard matrix equation to get standard XYZ value;

Step 2, Based on above standard matrix equation; calculate tristimulus value of following 8 primaries: red, green, blue, secondary color cyan, magenta, yellow, white of equal T and black point. The chromaticity coordinates of above colors share a common feature: there are two chromaticity coordinates in RGB equals 0; there is one chromaticity coordinate equals 0 in RGB; three chromaticity coordinates are all equal to 1 or 0. Put 8 values of chromaticity coordinate into above matrix equation; we can get 8 sets of tristimulus:

[Xₑᵣ Yₑᵣ Zₑᵣ],[X_{eg} Y_{eg} Z_{eg}], [X_{eb} Y_{eb} Z_{ed}],[X_{ec} Y_{ec} Z_{ec}],[Xₑₘ Yₑₘ Zₑₘ],[X_{ey} Y_{ey} Z_{ey}],[X_{ew} Y_{ew} Z_{ew}],[Xₑₖ Yₑₖ Zₑₖ]

Step 3, Choose suitable Liu's segment equation based on primary hue of the color XYZ (got by camera and calculated in step 1). Separate XYZ into brightness and chromatic difference signal. The segment equation at camera end is as follows:

$$\{ \begin{matrix}X = [ ( 1 - g ) ( 1 - b ) {X}_{ek} + g ( 1 - b ) {X}_{eg} + b ( 1 - g ) {X}_{eb} + {gbX}_{ec} ] \cdot ( 1 - {p}_{e} ) + {p}_{e} \cdot {X}_{ew} \\ Y = [ ( 1 - g ) ( 1 - b ) {Y}_{ek} + g ( 1 - b ) {Y}_{eg} + b ( 1 - g ) {Y}_{eb} + {gbY}_{ec} ] \cdot ( 1 - {p}_{e} ) + {p}_{e} \cdot {Y}_{ew} \\ Z = [ ( 1 - g ) ( 1 - b ) {Z}_{ek} + g ( 1 - b ) {Z}_{eg} + b ( 1 - g ) {Z}_{eb} + {gbZ}_{ec} ] \cdot ( 1 - {p}_{e} ) + {p}_{e} \cdot {Z}_{ew}\end{matrix} \\ \{ \begin{matrix}X = [ ( 1 - r ) ( 1 - b ) {X}_{ek} + r ( 1 - b ) {X}_{er} + b ( 1 - r ) {X}_{eb} + {rbX}_{em} ] \cdot ( 1 - {p}_{e} ) + {p}_{e} \cdot {X}_{ew} \\ Y = [ ( 1 - r ) ( 1 - b ) {Y}_{ek} + r ( 1 - b ) {Y}_{er} + b ( 1 - r ) {Y}_{eb} + {rbY}_{em} ] \cdot ( 1 - {p}_{e} ) + {p}_{e} \cdot {Y}_{ew} \\ Z = [ ( 1 - r ) ( 1 - b ) {Z}_{ek} + r ( 1 - b ) {Z}_{er} + b ( 1 - r ) {Z}_{eb} + {rbZ}_{em} ] \cdot ( 1 - {p}_{e} ) + {p}_{e} \cdot {Z}_{ew}\end{matrix} \\ \{ \begin{matrix}X = [ ( 1 - r ) ( 1 - g ) {X}_{ek} + r ( 1 - g ) {X}_{er} + g ( 1 - r ) {X}_{eg} + {rgX}_{ey} ] \cdot ( 1 - {p}_{e} ) + {p}_{e} \cdot {X}_{ew} \\ Y = [ ( 1 - r ) ( 1 - g ) {Y}_{ek} + r ( 1 - g ) {Y}_{er} + g ( 1 - r ) {Y}_{eg} + {rgY}_{ey} ] \cdot ( 1 - {p}_{e} ) + {p}_{e} \cdot {Y}_{ew} \\ Z = [ ( 1 - r ) ( 1 - g ) {Z}_{ek} + r ( 1 - g ) {Z}_{er} + g ( 1 - r ) {Z}_{eg} + {rgZ}_{ey} ] \cdot ( 1 - {p}_{e} ) + {p}_{e} \cdot {Z}_{ew}\end{matrix}$$

Calculate pₑusing segment equation based on primary hue of XYZ Transmit pₑ as brightness signal of color XYZ.

In above equation, [Xₑᵣ Yₑᵣ Zₑᵣ],[X_{eg} Y_{eg} Z_{eg}],[X_{eb} Y_{eb} Z_{eb}],[X_{ec} Y_{ec} Z_{ec}],[Xₑₘ Yₑₘ Zₑₘ],[X_{ey} Y_{ey} Z_{ey}],[X_{ew} Y_{ew} Z_{ew}],[Xₑₖ Yₑₖ Zₑₖ] are calculated results in step 2.

Step 4, In order to calculate chromaticity component Xₜ, Yₜ, Zₜ in color X, Y, Z, Liu's segment equation can be rewritten into format of equivalent linear equation, and referred to as Liu's linear segment equation:

$$\{ \begin{matrix}X = {X}_{t} \cdot ( 1 - {p}_{e} ) + {p}_{e} \cdot {X}_{w} \\ Y = {Y}_{t} \cdot ( 1 - {p}_{e} ) + {p}_{e} \cdot {Y}_{w} \\ Z = {Z}_{t} \cdot ( 1 - {p}_{e} ) + {p}_{e} \cdot {Z}_{w}\end{matrix}$$

Right side of above equation shows color X, Y, Z is separated into 2 components: brightness component and color difference component. Put pₑ (calculated in step 1) into the equation, we can get color difference parameter Xₜ, Yₜ, Zₜ

Xₜ=(Xₑ−pₑ·X_{w})/(1−pₑ)

Yₜ=(Yₑ−pₑY_{w})/(1−pₑ)

Zₜ=(Zₑ−pₑ·Z_{w})/(1−pₑ)

Step 5, Calculate chromaticity coordinates xₜ, yₜ of color difference parameter Xₜ, Yₜ, Zₜ:

xₜ=Xₜ/(Xₜ+Yₜ+Zₜ), yₜ=Yₜ/(Xₜ+Yₜ+Zₜ)

When transmit color XYZ to receiving end, xₜ, z_{y} values should be transmitted as chromatic aberration signal and pₑ value as brightness signal.

Beneficial effects: The segment equation can ensure color XYZ (got by camera) is transmitted to displaying end with unchanged hue, brightness and ratio of chromaticity coordinates.

11. The Method to Restore Tristimulus Values XYZ at Image Receiving End

Liu's restoring equation:

Based on received chromaticity coordinate xₜ, z, and gray component value pₑ, tristimulus value XYZcan be restored using Liu's restoring equation as following:

$$\{ \begin{matrix}X = ( {x}_{t} / {y}_{t} ) \cdot ( 1 - {p}_{e} ) + {p}_{e} \cdot {X}_{w} \\ Y = {y}_{t} \cdot ( 1 - {p}_{e} ) + {p}_{e} \cdot {Y}_{w} \\ Z = ( 1 - {x}_{t} - {y}_{t} ) \cdot ( 1 - {p}_{e} ) + {p}_{e} \cdot {Z}_{w}\end{matrix}$$

Beneficial effects of this method:

In the equation, because of pₑ and (1−pₑ), the hue and ratio (between chromaticity coordinates of the color to be transmitted) will not change even random deviation occurs to brightness, so color appearance remains unchanged. The brightness of image details can be loyally reproduced. Even for saturated colors, this restoring method also works and is very straightforward.

12. A Method to do Gamma Correction using Pipe-Line Function

Application the method:

When SMPTE standard was set up, the inevitable evolutional trend of display technology has been in people's view already. So, the set objective is: the display system need to be able to perform different colorimetric conversion and gamma correction for devices using different display technologies (e.g. CRT, PDP, LCD, LED, etc.). This means the gamma correction method according to γ=0.45 which has been used for decades are out of date. Different kinds of display devices, such as CRT, PDP, LCD, LED, etc., must perform their own gamma correction and colorimetric conversion in accordance with their specific gamma characteristic, which is a logical and achievable technology goal.

Currently there is a method: gamma correction is done based on the CRT's gamma γ=0.45 at camera end, and gamma effect get eliminated later at display end. Gamma match is achieved by using built-in programmable chromatic correction circuit based on PDP, LCD monitors' own gamma value. This method does work on traditional CRT television devices, but it is not really applicable to the new PDP, LCD, LED monitor which are more popular than CRT nowadays, because it will produce cumulative error, is short of commonality and not conducive to standardize. Therefore it should be seen as temporary solution only. With regard to computer image transmission, the method should be discarded as soon as possible. This invention introduces a general gamma correction method which is applicable to different type of monitors. Incorporate this method with color appearance keeping parameter λ will ensure both chromatic and visual fidelity for reproduced color.

Procedures of the method:

Step 1, Calculate gray component value [p′ᵥᵢ] based on the known gray component value function and driving value array [dᵥᵢ]:

pᵥ′=dᵥ^{yγ}^{_{pd}}

Step 2, According to television broadcasting standard, the brightness of camera end equation is as follows: for NTSC standard:

Y=0.2966R+0.5888G+0.11468

For PAL-D standard:

Y=0.2421R+0.6855G+0.07248

Given Rᵢ=Gᵢ=Bᵢ=dᵥᵢ, put the digital driving value array [0,0,0], [4,4,4], [8,8,8], [12,12,12], . . . , [255, 255,255] into above brightness equation to calculate camera end gray brightness array [Yₑᵢ];

Step 3, Calculate gray component value array [pₑᵢ] based on gray brightness array [Yₑᵢ]: given pₑᵢ=(Yₑᵢ/Y_{we}), we can calculate gray component value array [pₑᵢ] of camera side;

Step 4, Let [pᵥᵢ'] array be dependent variable and [pₑᵢ] be independent variable, do data fitting; then we will get a new function. To avoid confusion, the new function is referred to as pᵤ.

pᵤ=pᵥ′=pₑ^{γ}^{ᵥₑ}

Function pᵤ reflects mapping relationship between gray component value pₑat image sending end and gray component value p,' at displaying end. Function pᵤ is the pipeline that links sending and receiving end. Gray component value after gamma correction on any monitors can be calculated based on gray component value pₑ from sending end: pᵥ′=pᵤ=pₑ^{γ}^{ᵥₑ}

So, function pᵤ is called Liu's pipe-line function;

Step 5, Put value of function pᵤ into XYZ—rᵥ′gᵥ′bᵥ′—dᵣd_{g}d_{b} gamma correction process to calculate primary value rgb;

Step 6, Driving value dᵣ, d_{g}, d_{b} can be calculated based on primary value rgb. Use dᵣ, d_{g}, d_{b} to drive the monitor, the color after gamma correction can be displayed. The actual application of the gamma correction process will be covered in application steps below.

### IV. DESCRIPTION OF DRAWINGS

FIG. 1 Flowchart of gray calibration equations and gray core parameter characterization.

FIG. 2 Processing model for XYZ—rᵥgᵥbᵥ—dᵣd_{g}d_{b} conversions.

FIG. 3 Processing model for gamma correction process.

FIG. 4 Flowchart of XYZ—rᵥ′gᵥ′bᵥ′—dᵣd_{g}d_{b} conversion.

### V. SPECIFIC IMPLEMENTATION MODALITIES

With reference to attached figures and diagrams, here are implementation principles and detailed process taking television and computer monitor as examples.

1. Procedure to Characterize Liu's Gray Calibration Equation

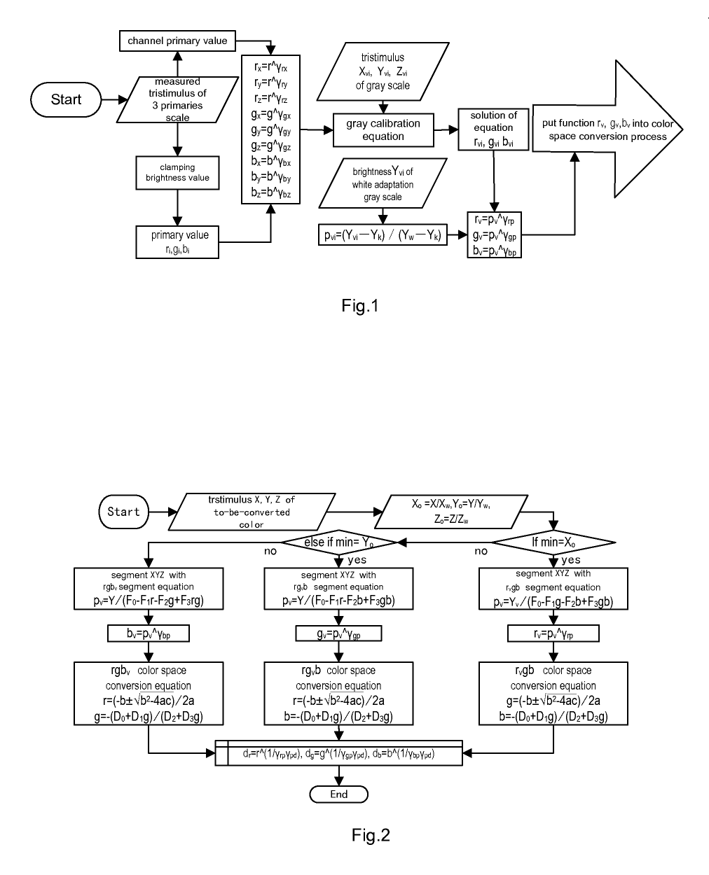

(1) Prepare characterization data for Liu's gray calibration equation: with reference to top left of FIG. 1, the problem to be solved is to obtain all values of power function exponent in Liu's calibration equation.

It can be achieved by following steps:

Step 1, Adjust the monitor to required standard working condition;

Step 2, Determine sample colors to be measured: three primaries red, green and blue, and gray sample mixed by three primaries with equal amount. The driving value of four scale samples which range between 0-255 are displayed and measured in accordance with 41 levels in ascending order. For the four scales, the corresponding input values are the same, i.e. let ibe the progression of input driving value, and display series of sample color red, green, blue and gray are referred to as iᵣ, i_{g}, i_{b}, iₛ. In this the case, iᵣ=i_{g}=i_{b}=iₛ=i=41. Tristimulus values of yellow, cyan, and magenta also need to be displayed and measured. The input values are (R255+G255), (R255+B255), (G255+B255) respectively.

Step 3, Measure and record tristimulus value XYZof above sample colors.

(2) Calculate reference primary component value of 3 sets of sample colors. Reference primary component value ranges between 0 and 1. Taking blue as example and here are steps to calculate reference primary component value. For red and green, solve same way.

Step 1, Calculate clamping brightness value Y_{tb} of primary blue based on below Liu's clamping brightness model:

$${Y}_{tb} = \frac{( {Y}_{b} - {Y}_{k} ) \cdot \{ \begin{matrix}X [ {Y}_{k} ( {Z}_{b} - {Z}_{k} ) - {Z}_{k} ( {Y}_{b} - {Y}_{k} ) ] - \\ Z [ {Y}_{k} ( {X}_{b} - {X}_{k} ) - {X}_{k} ( {Y}_{b} - {Y}_{k} ) ]\end{matrix} \}}{\begin{matrix}( {X}_{b} - {X}_{k} ) [ {Y}_{k} ( {Z}_{b} - {Z}_{k} ) - {Z}_{k} ( {Y}_{b} - {Y}_{k} ) ] - \\ ( {Z}_{b} - {Z}_{k} ) [ {Y}_{k} ( {X}_{b} - {X}_{k} ) - {X}_{k} ( {Y}_{b} - {Y}_{k} ) ]\end{matrix}}$$

Step 2, Calculate bᵢ's value of primary blue based on Liu's primary component value moder.

$$b = \frac{{Y}_{tb} - {Y}_{k}}{{Y}_{b} - {Y}_{k}}$$

Step 3, Calculate channel primary component value according to measured tristimulus values Xᵢ, Yᵢ, Zᵢ of blue:

bₓ=(X−Xₖ)/(X _{b}−Xₓ), b_{y}=(Y−Yₖ)/(Y_{b}−Yₖ), b_{z}=(Z−Zₖ)/(Z_{b}−Zₖ)

bₓ, b_{y}, b_{z} are channel primary component values of blue. The result are blue's primary component value array bₓᵢ,b_{yi}b_{zi};

Step 4, Use curve fitting method to construct function of channel primary component value. Perform curve fitting' on blue's reference primary component value array bᵣand d channel primary component value array bₓᵢ, b_{yi}, b_{zi}. The result is channel primary component value's power function expression and exponent of the power function.

bₓ=b^{γ}^{_{xb}}, b_{y}=b^{γ}^{_{yb}}, b_{z}=b^{γ}^{_{zb}}

Step 5, Use curve fitting method to construct the reference primary component value function.

Let b, be dependent array, and corresponding driving value d_{bi} be independent array; do data fitting. The results are power function expression of reference primary component value, and exponent of the power function.

The function is:

b=d_{b}^{γ}^{_{bd}} then d_{b}=b^{γ}^{_{bd}}

Step 6, Follow above steps we can get function of channel primary component value for red and green.

rₓ=dᵣ^{γ}^{ₓₜ}, r_{y}=dᵣ^{γ}^{_{yr}}, r_{z}=dᵣ^{γ}^{_{zr}}, gₓ=d_{g}^{γ}^{_{xg}}. g_{y}=d_{g}^{γ}^{_{yg}}, g_{z}d_{g}^{γ}^{_{zg}}

r=dᵣ^{γ}^{_{rd}}, dᵣ^{γ}^{_{rd}}, g=d_{g}^{γ}^{_{gd}}, d_{g}^{yγ}^{_{gd}}

Now we have done characteristic calibration for Liu's gray balance equation.

2. Characterization Process of Gray Core Function rᵥ, gᵥ, bᵥ, (Please Refer to the Left and Bottom Part of FIG. 1)

Step 1, Convert gray's tristimulus Xᵥᵢ, Yᵥᵢ, Zᵥᵢ of ‘visual adaptation gray scale to white point’ to their primary component value rᵥᵢ, gᵥᵢ, bᵥᵢ;

Step 2, Divide driving value dᵢ of 41 levels of gray by 255 respectively, thus they are normalized into sequential array which ranges between 0 and 1;

Step 3, Convert brightness value Yᵥᵢ in gray's tristimulus to gray component value pᵥᵢ using following model:

pᵥᵢ=(Yᵥᵢ−Yₖ)/(Y_{w}−Yₖ)

Step 4, Let primary component value rᵥᵢ, gᵥᵢ, bᵥᵢ be dependent variable, and white component value pᵥᵢ be independent variable; do data fitting, then we get power function expression of primary component value rᵥ, gᵥ, bᵥ.

The functions are: rᵥ=pᵥ^{γ}^{ᵣₚ}, gᵥ=pᵥ^{γ}^{_{gp}}, bᵥ=pᵥ^{γ}^{_{bp}}

Put above function rᵥ, gᵥ, bᵥ into XYZ—rᵥgᵥbᵥ—dᵣd_{g}d_{b} transformation process.

3. XYZ—rᵥgᵥbᵥ—dᵣd_{g}d_{b} Color Space Conversion

To better understand principle of XYZ—rᵥgᵥbᵥ—dᵣd_{g}d_{b} conversion, we will go through steps in FIG. 2 Step 1, Convert the to-be-calibrated color XYZ to tristimulus values X_{w}Y_{w}Z_{w} of white point, and get XₒYₒZₒ

Xₒ=X/X_{w}, Yₒ=Y/Y_{w}, Zₒ=Z/Z_{w}

Step 2, Find the minimum value min among XₒYₒZₒₜ then choose suitable segment equation for XYZ based on following conditions:

If min=Xₒ, choose rᵥgb segment equation;

If min=Yₒ, choose rgᵥb equation;

Otherwise, use rgbᵥ equation;

Step 3, Convert tristimulus XYZ using the chosen segment equation to solve gray component value pᵥ;

Step 4, Calculate gray core value rᵥ, or gᵥ, or bᵥ based on the known brightness component value pᵥ:

If pᵥ is from rᵥgb class segment equation, then rᵥ=pᵥ^{γ}^{ᵣₚ}

If pᵥ is from the rgᵥb class segment equation, then gᵥ=pᵥ^{γ}^{_{gp}}

If pᵥ is from the rgbᵥ class segment equation, then bᵥ=pᵥ^{γ}^{_{bp}}

Step 5, Put gray core value rᵥ, or gᵥ, or bᵥ into chosen XYZ—rᵥgᵥbᵥ—dᵣd_{g}d_{b} conversion equation to calculate two reference primary component values and Liu's keeping color appearance parameter λ. Taking Liu's transformation equation of rᵥgb class as example, the solutions obtained after conversion are: primary component value r=rᵥ, g, b, and Liu's color appearance keeping parameter λ;

Step 6, Calculate driving values dᵣ, d_{g}, d_{b} based on primary component value r, g, b: i.e. let dᵣ=r^{yγ}^{ᵣₚ}^{γ}^{_{dp}}, d_{g}=g^{yγ}^{_{gp}}^{γ}^{_{dp}}, d_{b}=b^{yγ}^{_{bp}}^{γ}^{_{dp}}

4. XYZ—rᵥ′gᵥ′bᵥ′—dᵣd_{g}d_{b} Gamma Correction Process

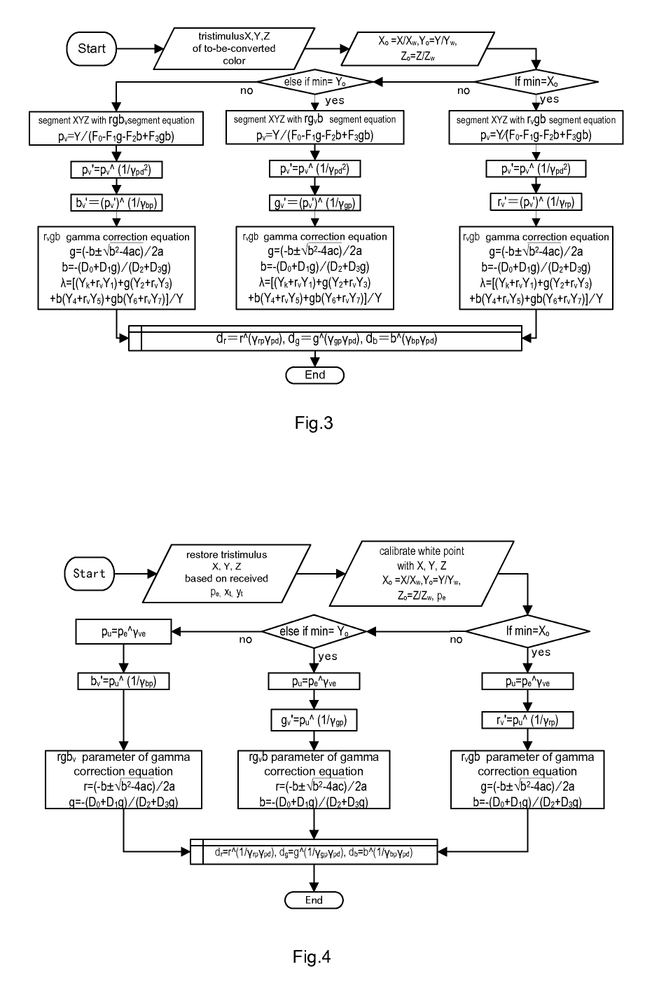

To better understand principles of gamma correction, we will go through steps in FIG. 3.

Step 1, convert to-be-calibrated color XYZ to tristimulus values X_{w}Y_{w}Z_{w} of white point,

Xₒ=X/X_{w}, Yₒ=Y/Y_{w}, Zₒ=Z/Z_{w}

Step 2, find the minimum value min among XₒYₒZₒ, then choose suitable segment equation for XYZ based on following conditions:

If min=X₀, choose rᵥgb segment equation;

If min=Yₒ, choose rgᵥb equation;

Otherwise, use rgbᵥ equation;

Step 3, Convert tristimulus XYZ using the chosen segment equation to solve gray component value pᵥ;

Step 4, Apply gamma correction on tone of pᵥ: pᵥ′=pᵥ^{γy}^{²}^{_{dp}}

Step 5, Calculate gray component value rᵥ′, gᵥ′, bᵥ′ for gamma correction equation based on gray component value pᵥ′; the rule is:

If rᵥgb class segament equation is chosen, calculate rᵥ′ only;

If rgᵥb class segment equation is chosen, calculate gᵥ′ only;

If rgbᵥ class segment equation is chosen, calculate bᵥ′ only;

i.e. rᵥ′=(pᵥ′)^{y}^{_{γr}}, gᵥ′=(pᵥ′)^{yγ}^{_{gp}}, bᵥ′=(pᵥ′)^{yγ}^{_{bp}}

Above is a principle oriented process. In practical applications, such as transmitting digital image or television system, the mission of color segment equation are fulfilled at the image-taking end. The color is segmented into gray component and chromatic difference component, which get transmitted to receiving-end. Step 6, Pass primary component value rᵥ′, gᵥ′, bᵥ′ into corresponding XYZ—rᵥ′gᵥ′bᵥ′—dᵣd_{g}d _{b} gamma correction equation, and we can get two mapping primary component values and Liu's color appearance keeping parameter λ;

Step 7, Calculate driving values dᵣ, d_{g}, d_{b} based on rᵥ′, gᵥ′, bᵥ′

dᵣ=r^{y}^{ᵣₚ}^{γ}^{_{dp}}, d_{g}=g^{γ}^{_{gp}}^{γ}^{_{dp}}, d_{b}=b^{γ}^{_{dp}}^{γ}^{_{dp}}

5. The Practical Application of XYZ—rᵥ′gᵥ′bᵥ′—dᵣd_{g}d_{b} Conversion Process: (Please Refer to FIG. 4)

XYZ—rᵥgᵥbᵥ—dᵣd_{g}d_{b} conversion principle and XYZ—rᵥ′gᵥ′bᵥ′—dᵣd_{g}d_{b} gamma correction principle reflect the principle of workflow and derivation logic. Segment equation is a step in both processes. In terms of cost and efficiency, complete the segment process on camera end (image taking) is more favorable than on receiving end (image displaying). It can help TV and computer users lower their cost. In practical application of XYZ—rᵥ′gᵥ′bᵥ′—dᵣd_{g}d_{b} gamma correction process, the task of color segmentation has been shift from XYZ—rᵥ′gᵥ′bᵥ′—dᵣd_{g}d_{b} gamma correction equation to camera end. In practical application of the XYZ—rᵥ′gᵥ′bᵥ′—dᵣd_{g}d_{b} gamma correction process, the original function pᵥ′ has been replaced with the pipeline function p_{g}. This method makes XYZ—rᵥ′gᵥ′bᵥ′—dᵣd_{g}d_{b} gamma correction process simple, accurate and efficient. For better understanding of above process, we will go through the steps in FIG. 4:

Step 1, Restore tristimulus value XYZ from sending end using Liu's restoration equation based on the received parameter pₑ and chromaticity coordinates xₜ, yₜ ;

$$\{ \begin{matrix}X = ( {x}_{t} / {y}_{t} ) \cdot ( 1 - {p}_{e} ) + {p}_{e} \cdot {X}_{w} \\ Y = {y}_{t} \cdot ( 1 - {p}_{e} ) + {p}_{e} \cdot {Y}_{w} \\ Z = ( 1 - {x}_{t} - {y}_{t} ) \cdot ( 1 - {p}_{e} ) + {p}_{e} \cdot {Z}_{w}\end{matrix}$$

Step 2, Convert to-be-calibrated color XYZ to white point's tristimulus value X_{w}Y_{w}Z_{w},

Xₒ=X/X_{w}, Yₒ=Y/Y_{w}, Zₒ=Z/Z_{w}

Step 3, Find the minimum value min among XₒYₒZₒ, then choose suitable conversion path for Xₑ, Yₑ, Zₑ based on following conditions:

If min=Xₒ, choose calculation path of rᵥgb class;

If min=Yₒ, choose calculation path of rᵥgb class;

Otherwise, choose calculation path of rgbᵥ class. This process can be done quickly by using circuit.

Step 4, Calculate pipe-line parameter pᵤ based on gray component value pₑ which is from camera end,

pᵤ=pₑ^{y}^{ᵣₑ}

Step 5, Calculate gray core value rᵥ′ or gᵥ′ or bᵥ′ a by chosen calculation path;

Step 6, Calculate other two primary component values based on rᵥ′ or gᵥ′ or bᵥ′;

Step 7, The driving values dᵣd_{g}d_{b} which is required for display can be calculated based on primary component value rgb.

1. An image transmission and display method complying with chromaticity and visual fidelity principle, and it is characterized by:
(1) The entire process of image information transmission and display conform to both chromaticity and visual fidelity principles;
(2) The innovative primaries clamping equation and its derived parameter model eliminated red-shift effect, revealed and quantified true relationship between a primary's hue, colorfulness and brightness, so it can give ‘channel independence’ to primaries ;
(3) Use the innovative gray calibration equation to represent the functional relations between XYZ and channel primaries value, reference primaries value and digital input value. Thus ‘channel independence’ and ‘space independence’ of primaries can be kept while matching a color;
(4) First calibrate and characterize gray calibration equation using primaries damping equation and its derivative parameter model, then calibrate and characterize the ‘visual adapted gray scale to white-point ’ using gray calibration equation to obtain gray core function, and channel independence is also inherited by the gray core parameter;
(5) Perform color space transformation calculation using the innovative XYZ—rᵥgᵥbᵥ—dᵣd_{g}d_{b} color space transformation equation;
(6) Implement the gamma correction using the innovative XYZ—rᵥ′gᵥ′bᵥ′—dᵣd_{g}d_{b} gamma correction equation. By using gray core value and parameter λ, primary values rgb in gamma correction equation obtain ‘channel independent characteristic’;
(7) Use the non-linear and linear brightness—chromatic difference segment equation respectively to separate the color's tristimulus values into gray component and chromatic component. They are used as the brightness and chromatic difference information to restore the transmitted color at display end;
(8) At the display end, restore color's tristimulus values fast using the innovative restoring color equation;
(9) Use the innovative pipe-line function as communication channel between image transmission and display end, so that the images from the camera end taking image for TV can be displayed accurately on a variety of display devices like CRT, PDP, LCD, LED, etc;

2. A XYZ—rᵥgᵥbᵥ—dᵣd_{g}d_{b} color space transformation equation, which is used to implement claim 1, and characterized by:
(1) The transformation equation has three innovative formats—rᵥgb, rgᵥb, rgbᵥ, which divide to-be-transformed color space into three sub-domains to perform transformation accurately;
(2) The gray core parameters rᵥ, gᵥ, bᵥ in the equation have characteristic of reference primary value and are related to white balance and gamma correction. Both gray core parameters and color appearance keeping parameter λ sure the transformed color keep the same hue before and after transformation, and keep good color purity, gray balance and gamma adaptation characteristic;
(3) The transformation equation is a quadratic equation. It can be simplified into simple format and resolved with analytical algorithms;

3. A XYZ—rᵥ′gᵥ′bᵥ′—dᵣd_{g}d_{b} gamma correction equation, which is used to implement claim 1, and characterized by:
(1) This equation has all characteristics in above color space transformation equation;
(2) It embodies equation's function of gamma correction in the gray core value rᵥ′, gᵥ′, bᵥ′;

4. A primaries clamping equation and its derived parameter models, which is used to implement claim 1, and characterized by:
(1) The primaries clamping equation has innovative and unique format; it has three variable parameters: color appearance keeping parameter λ, clamping brightness Yₜ and clamping primaries value aₜ;
(2) Clamping equation can accurately describe and quantify the relationship between the three attributes of primary colors; color appearance keeping parameter λ can reveal different red shift effect of primaries with different wavelength;
(3) The color represented by clamping primaries value aₜ always has the same hue as unit primary color, (4) The primary clamping equation gives primary colors ‘channel independent characteristic’;

5. A mathematical model for calculating reference primary value, which is used to implement claim 1, and characterized by:
(1) The model to calculate reference primary value has innovative and unique format;
(2) The color represented by reference primary value a has clamping brightness value Yₜ, which represents the color's ‘pure’ brightness;
(3) The color represented by reference primary value a always has the same hue as the unit primary value;
(4) Compare primary's tristimulus values represented by reference primary value a with the measured tristimulus values, their stimulus value X and Z remain unchanged;

6. A gray calibration equation, which is used to implement claim 1, and characterized by:
(1) It has innovative and unique format;
(2) The tristimulus values XYZto be match by gray calibration equation are function of channel primary values rₓ, r_{y}, r_{z}, gₓ, g_{y}, g_{z}, bₓ, b_{y}, b_{z} which exist as independent variables;
(3) Channel primary values rₓ, r_{y}, r_{z}, gₓ , g_{y}, g_{z}, bₓ, b_{y}, b_{z} are power functions of reference primary r, g, b respectively; channel primary value and reference primary value are new concepts created by this invention;
(4) Reference primary value r, g, b are power functions of driving values dᵣ, d_{g}, d_{b} respectively;
(5) This calibration equation can calibrate image's gray tone to reference primary value; here the ‘visual adapted to white point’ of gray tone has also been taken into account;

7. A method to characterize gray calibration equation, which is used to implement claim 6, and characterized by:
(1) The method is based on primaries clamping equation, and with ‘reference primary value’ as medium, the characterization is done by using data fitting method;
(2) Channel primary value is power function with reference primary value as independent parameter; power function's exponent after characterization is associated with red shift effect of primary color;
(3) Reference primary value is power function of driving value; power function's exponent after characterization reflects the nonlinear characteristic of the displaying primary color;

8. A brightness-chromaticity segment equation, which is used to implement claim 1, and characterized by:
(1) The equation has innovative format;
(2) The equation has three different types (rᵥgb, rgᵥb, rgbᵥ), which satisfy the requirements of accurate and fast transformation;
(3) The equation can accurately segment a certain color with tristimulus value XYZ into gray and color component using gray component parameter pᵥ and chromatic component (1−pᵥ); when gray component parameter pᵥ changes from 0 to 1 by established steps, the serial gray components actually show itself a visual adapted gray scale to white point, and each level on the scale has the same chromaticity coordinates as white point;
(4) The gray component value pᵥ can be used to calculate gray core parameters rᵥ, gᵥ, bᵥ easily;
(5) For television and digital camera, if segment equation is used to generate brightness and chromaticity signals for image transmission, then only brightness value pₑ and color chromaticity coordinates xₜ, yₜ need to be sent to restore the transmitted color's tristimulus values on receiving end, thus incurred chromaticity loss due to system non-linear can be avoided;
(6) The segment equation is a quadratic equation; it can be simplified into algebraic expression and resolved with analytic algorithms;
(7) Black point's tristimulus values Xₖ, Yₖ, Zₖ are parameters closely related with transformation calculation; although the values of this set of data are smaller, normalized tristimulus values cannot be seen as subtraction of measured tristimulus values with black point's tristimulus values, the method do not subtract black point's tristimulus values from measured tristimulus values, as processing measured tristimulus values;

9. A method to create visual adapted gray scale to white point, which is used to implement claim 2, and characterized by:
(1) The data to generate gray scale brightness value are based on measured brightness value [Yᵥᵢ] driven by three primaries (their driving values are equal);
(2) Brightness value Yᵥ of each level on the gray scale is the function of gray component value pᵥ; gray component value pᵥ is power function of input driving value dᵢ;
(3) Each level's chromaticity coordinates are equal to white point's chromaticity coordinates;

10. A method to create and characterize gray core function, which is used to implement claims 2 and 3 and it is characterized by:
(1) Gray core parameters are three reference primary values matching with ‘visual adapted gray scale to white point’; they are obtained with the new created gray calibration equation and characterization process;
(2) As for any color deviated from ‘gray’ in vision, the primary with least amount constitutes this color's gray core, the other two primary components are ‘primary value deviated from gray core’;
(3) In XYZ—rᵥgᵥbᵥ—dᵣd_{g}d_{b} color space transformation equation, gray core function r_{y} or gᵥ or bᵥ is power function generated with data fitting method, with gray core parameters rᵥgᵥbᵥ as dependent variable and gray component pᵥ as independent variable; the values of three primaries rgb are determined by gray core value r_{y} or gᵥ or bᵥ separately and color appearance keeping parameter λ; driving parameters dᵣd_{g}d_{b} is power function with primary value rgb as independent variable;
(4) In XYZ—rᵥ′gᵥ′bᵥ′—dᵣd_{g}d_{b} gamma correction equation, gray component parameter pᵥ′ is power function with gray component parameter pᵥ as independent variable; the values of three primaries rgb are determined by gray core value rᵥ′gᵥ′bᵥ′ and color appearance keeping parameter λ; driving parameters dᵣd_{g}d_{b} is power function with primary value rgb as independent variable;
(5) The innovative method to create and characterize gray core function incorporates eight basic methods and procedures;

11. A non-linear method to generate brightness signal and color difference signal at camera end, which is used to implement claim 1, and characterized by:
(1) This method is not based on three primary color voltage values; instead, brightness and chromatic difference signal are generated based on standard tristimulus values to-be-transmitted color,
(2) This method uses above non-linear brightness-color difference segment equation to obtain brightness information, and uses above linear brightness- color difference segment equation to obtain color difference information;
(3) The new created non-linear brightness—color difference segment equation and linear brightness—color difference segment equation both have new and unique formats;
(4) Brightness information keeps its independent characteristic during transmission process; color difference information retains the same ratio of chromaticity coordinates; the hue remains unchanged;
(5) It has innovated steps to generate brightness information pₑ and color difference information xₜ, yₜ;

12. A method to restore tristimulus values X, Y, Z at the image receiving end, which is used to implement claim 1, and characterized by:
(1) Model of restoring tristimulus values has unique and innovative format;
(2) This method restores tristimulus values of source color from sending end using received gray scale parameter pᵥ and chromaticity coordinate xₜ, yₜ;

13. A method to achieve gamma correction by creating pipeline function which is used to implement claim 1, and characterized by:
(1) Create a new method to generate gray component parameter array [pₑᵢ] at camera end;
(2) Use the new created pipe-line function Pᵤ=Pₑ^{γve} as communication channel between gamma characteristics of camera and display end;
(3) A unique method to create pipe-line function; it has four steps:
a. Calculate gray component parameter array [pᵥᵢ′] based on gray component parameter mode;
b. Let Rᵢ=Gᵢ=Bᵢ=dᵥᵢ, calculate brightness array [Yₑᵢ] at camera end;
c. Calculate gray gray component parameter array [pₑᵢ] according to brightness array [Yₑᵢ];
d. Obtain pipe-line function pᵤ by fitting array [pₑᵢ] and array [pᵥᵢ];
(4) Use pipe-line function pᵤ to express the mapping relationship between gray component parameter at image sending end and gray component parameter at receiving end;
(5) Introduce function pᵤ into the practical application of gamma correction process, then achieve purpose of gamma correction;
(6) This method is applicable to all current display devices because array [pᵥᵢ′] is always associated with the type of relevant display device;

14. A XYZ—rᵥgᵥbᵥ—dᵣd_{g}d_{b} color space transformation process, which is used to implement claim 2, and characterized by:
(1) Choose proper transformation equation based on a color's to-be-transformed primary hue, i.e. divide the color's to-be-transformed space into three sub-domains to perform transformation;
(2) Calculate color's gray component value pᵥ using brightness—chromatic difference segment equation;
(3) Calculate gray core parameters rᵥ, or gᵥ, or bᵥ based on calculated pᵥ;
(4) Calculate the other two reference primary values using analytical algorithm;
(5) Calculate driving values dᵣ, d_{g}, d_{b} based on reference primary values;

15. A XYZ—rᵥ′gᵥ′bᵥ′—dᵣd_{g}d_{b} gamma correction process, which is used to implement claim 3, and characterized by:
(1) Choose proper transformation equation based on a color's to-be-transformed primary hue, i.e. divide the color's to-be-transformed space into three sub-domains to perform transformation;
(2) Calculate color's gray component parameter pᵥ using brightness—chromatic difference segment equation;
(3) Perform gamma correction on pᵥ to obtain mapping gray component parameter pᵥ;
(4) Calculate gray core value rᵥ′, or gᵥ′, or bᵥ′ based on pᵥ′;
(5) Calculate other two reference primary values using analytical algorithm;
(6) Calculate driving values dᵣ, d_{g}, d_{b} based on reference primary values;

16. A practical application of XYZ—rᵥ′gᵥ′bᵥ′—dᵣd_{g}d_{b} conversion process which is used to implement claim 1 and is characterized by:
(1) Simplify the complex color information transformation process into a simple, efficient and practical process;
(2) Use the new created recovery equation to restore tristimulus XYZ from TV camera end;
(3) Perform calibration against to-be-transformed XYZ with reference white;
(4) Choose proper conversion path according to XYZ's primary hue;
(5)With pipe-line function, map XYZ's gray scale parameter from source end pₑ to display end Pᵤ ;
(6) Calculate gray core value rᵥ′ or gᵥ′ or bᵥ′ based on gray scale parameter value pᵤ;
(7) Calculate reference primary value rgb based on gray core value rᵥ′gᵥ′bᵥ′;
(8) Calculate driving value dᵣd_{g}d_{b} based on reference primary value rgb.
